(19) United States
(12) Patent Application Publication
(10) Pub. No.: US 2023/0168995 A1
(43) Pub. Date: Jun. 1, 2023

(54) SYSTEM AND A METHOD FOR DETECTING AND CAPTURING INFORMATION CORRESPONDING TO SPLIT TESTS AND THEIR OUTCOMES

(71) Applicants: Gajan Retnasaba, Atlanta, GA (US); Abhishek Mohata, Surat (IN); Kushal Borda, Surat (IN); Angelica Marbella, NCR (PH); Yaseen Shaik, Hyderabad (IN); Hassan Ahmad, Lahore (PK); Manu Sharma, New Delhi (IN); Yuriy Kycha-Kolot, Kyiv Oblast (UA)

(72) Inventors: Gajan Retnasaba, Atlanta, GA (US); Abhishek Mohata, Surat (IN); Kushal Borda, Surat (IN); Angelica Marbella, NCR (PH); Yaseen Shaik, Hyderabad (IN); Hassan Ahmad, Lahore (PK); Manu Sharma, New Delhi (IN); Yuriy Kycha-Kolot, Kyiv Oblast (UA)

(21) Appl. No.: 17/535,741

(22) Filed: Nov. 26, 2021

(51) Int. Cl. G06F 11/36; G06F 8/70; G06F 16/958

(52) U.S. Cl. CPC G06F 11/3688; G06F 8/70; G06F 16/958

(57) ABSTRACT

A system and a method for detecting and capturing information corresponding to split tests and their outcomes are disclosed. The system identifies a split test being run on a third-party website or web page. The split test comprises one or more experimental arms corresponding to modifications of the third-party website or web page. The system identifies the arms of the split test and monitors changes in traffic allocation to the arms of the split test. Further, the system identifies one or more experimental arms as being winner arms based on an increase in the traffic allocation to the arms or modifications contained in the arm or arms being detected on the website or web page following the conclusion of the test. In one embodiment, the system identifies one or more experimental arms as being winner arms when the traffic is allocated substantially or completely to the arms. The system terminates identification of the split test being run on the third-party website or web page upon detection of the winner arms.

### FIELD OF INVENTION

The present invention generally relates to evaluating changes to a website or web pages. More specifically, the present invention relates to detecting and capturing information about online split tests and their outcomes.

### BACKGROUND OF INVENTION

It is known that owners and operators of websites and software applications are increasingly turning to split testing to determine if some change, or set of changes, to a website, application, or other media leads to an increase or decrease in key metrics. Split testing is a technique used to measure the impact of a change on key metrics. Split testing is most widely used to measure conversion rates, the fraction of users that perform some desired action. Common conversion metrics measured include the fraction of visitors who make a purchase, fill out a lead form, register for a demo or webinar or digital resource, download or install some application, call, text, or request a quote. In addition to conversions, a wide variety of engagement metrics such as site engagement metrics (e.g., time on site, pages visited, exit rates, bounce rates, etc.) are also measured. Additionally, intermediate metrics that represent steps toward some desirable end goals are also considered. Intermediate metrics including the rates of visitors that add an item to cart, reach a product page, click a call-to-action (CTA), or progress through a funnel. Conversion metrics are often combined with lead scoring or predictive analytics systems that account for the differences in value of different types of conversions over others.

Split testing involves making one or more changes to a user experience, and allocating visitors between two or more of the new and existing experiences. One or more metrics of interest are measured for each of the experiences being tested. These measurements are used to calculate differences in metrics between the experiments that are due to the changes made to the experience. This data is often analyzed using statistical, machine learning, or other data analysis techniques to determine whether one or more experiences is superior at producing a desired outcome or set of outcomes. Experiences that outperform or that outperform by some statistical threshold are typically retained, and experiences that lose are discarded. The winning experience may then be tested against other experiences in further rounds of testing. In testing terminology, the existing experience is often referred to as the control, and the new experiences being tested against the control are often referred to as variants or variations. Collectively, the control and the variations of a particular experience/experiment are referred as “arms” of the experiment.

There are a variety of known split testing methodologies that are used to allocate traffic between the test experiences and to determine what if any experience is the winner. Examples of split testing methodologies include, but are not limited to, A/B testing, multivariate testing, bandit testing, Taguchi testing, and other types of statistical and artificial intelligence (AI) powered testing.

Currently, the owners and operators of websites and software applications depend on past results from their own website, research techniques, past experience, general design and conversion optimization principals, and observations of competitors and peers' websites for predicting whether a particular change to a website is likely to have high potential.

In addition, several methods have been disclosed in the past for predicting whether a particular web change is likely to have high potential. One such exemplary method is disclosed in a U.S. Pat. No. 9,792,365, entitled “Method and system for tracking and gathering multivariate testing data” (“the '365 patent”). The '365 patent discloses a system and method for tracking and gathering data respective of multivariate testing on a plurality of web pages. The method includes crawling through a plurality of servers hosting the plurality of web pages; for each uniform resource locator (URL) of a webpage of the plurality of web pages encountered during the crawling: sending a request to download the webpage identified by the URL; downloading at least one page view of the webpage; analysing the at least one downloaded page view to identify data related to at least a multivariate test; and saving data identifying the at least a multivariate test performed in the plurality of web pages in a data store.

Another example is disclosed in a United States Publication no. 20150026522, entitled “Systems and Methods for Mobile Application A/B Testing” (“the '522 Publication”). The '522 Publication discloses techniques for electing winner treatments in connection with A/B testing of mobile applications. According to various embodiments, the activation of a version of a mobile application installed on a mobile device may be detected. A database storing winner treatment information describing one or more winner treatments for one or more A/B tests is accessed. In some embodiments, each of the one or more A/B tests in the winner treatment information may be associated with a particular version of a particular mobile application. Thereafter, a specific winner treatment for a specific A/B test associated with the version of the mobile application installed on the mobile device may be determined, based on the winner treatment information. The specific winner treatment may then be implemented in the mobile application installed on the mobile device.

Yet another example is disclosed in a U.S. Pat. No. 10,255,173, entitled “Experimentation in internet-connected applications and devices” (“the '173 patent”). The '173 patent discloses a content variation experiment system for performing variation testing of web pages. A content provider receives requests for a web page undergoing an experiment. The content provider determines a variation from a plurality of variations of the web page to provide to the user. The content provider makes the determination without sending a network request to an experiment definition system used to define the experiment thereby reducing network latency.

Although the above-discussed methods are capable of predicting whether a particular web change is likely to have high potential, they have a few problems. For instance, the current split testing program is limited in generating ideas for successful high potential split tests as they do not have a larger set of test ideas. This is because; the operators of websites and software applications typically generate ideas by looking at peer websites, by conducting research on their site to identify reasons why visitors are not converting, by examining their website analytics, by creative brainstorming, or by referring to published test ideas. But, the set of ideas that the operators of websites and software applications conduct is typically limited by the breadth of their observation, experience, and imagination.

In addition, the current split testing programs do not provide a mechanism to prioritize ideas for testing. As each test requires a sufficiently large sample size to provide accurate results and running tests imposes financial, resource, management, and other costs, the number of tests that can be run over a given time period is limited. Thus, testing programs are faced with difficult decisions regarding which test to prioritize given the choice between multiple potential tests and have very limited data with which to make these decisions.

Based on the above, it is desirable to identify the highest potential testing ideas so that these ideas can be prioritized. Further, it is desirable to identify low potential testing ideas so that these tests can be deprioritized.

Therefore, there is a need for an improved system and method for detecting and capturing information about split tests and their outcomes, a system that allows businesses to be able to generate more ideas for potential tests and have a way to evaluate potential tests.

### SUMMARY OF THE INVENTION

It is an object of the present invention to provide a system and a method for detecting and capturing information about split tests and their outcomes and that avoids the drawback of known techniques.

It is another object of the present invention to provide a system that generates more ideas for potential tests and allows the evaluation of potential tests.

It is another object of the present invention to provide a system and a method for detecting tests running on third-party websites, applications, and other media and for capturing information about the tests and their outcomes in a way that can be useful in predicting tests that might be useful to run on a business's own property.

It is yet another object of the present invention to provide a system and a method for harvesting information and determining the efficacy of tests that run on third-party websites.

It is yet another object of the present invention to provide a system and a method for identifying a high volume of high potential test candidates by observing tests being run on third-party websites, and detecting signals/outcomes that a test was a winner or a loser.

In order to achieve the above-stated objects, the present invention provides a system and a method for detecting and capturing information corresponding to split tests and their outcomes. The system detects websites or web pages running split tests for generating a list of candidate websites or web pages. The system generates a list of candidate websites or web pages with testing software installed by using a web crawler. Alternatively, the system generates the list of candidate websites or web pages using pre-built lists, manually adding or removing sites, or automatically adding or removing sites. The system detects a webpage with testing software installed by using a web crawler by recognizing visual or code changes on a webpage, or executing a command, or detecting a code signature, or detecting cookies.

After generating the list of candidates, the system monitors split tests and changes on the website or web pages periodically by capturing page and test information. Here, the system scrapes the webpage or web pages multiple times to generate information about the number of arms and the relative amount of traffic allocated to each arm. The system further monitors allocation of traffic to the arms of the test experiments to obtain the outcomes such as winner experiments or “not-winner”/loser experiments. A winner experiment indicates an experiment where the traffic allocation is changed to allocate all or substantially all the available traffic to the website or web pages. The system monitors allocation of traffic until an experiment is identified as a winner experiment. The system captures data corresponding to the winner experiment.

In one technical feature of the present invention, the system detects the split tests running on third-party websites, applications, and other media and captures information about the split tests and their outcomes in a way that can be useful in predicting tests that might be useful to run on a business's own property.

In another embodiment of the present invention, the system scrapes the target webpage multiple times to generate information about the number of arms and the relative amount of traffic allocated to each arm. By utilizing a significantly large number of scraper runs, and detecting and collecting differences between each run, the number of arms and an estimate of the allocation of traffic to each of these arms can be estimated. This helps to increase the precision of these estimates as the number of runs (sample size) increases.

In one advantageous feature of the present invention, the system enables a business to identify a high volume of high potential test candidates. The system achieves this by observing tests being run on third-party websites, and detecting signals that a test was a winner or a loser.

In another advantageous feature of the present invention, the system periodically determines a set of websites or web pages that are currently running split tests, that are likely to run split tests in the future, or that are of particular interest. Periodically making such a determination allows resources to be preferentially allocated to analyzing the websites that are more likely to generate useful information. Further, this allows new tests being run on the websites to be added to a database and allows information to be gathered about the test outcome.

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates an environment in which a system for detecting and capturing information corresponding to split tests and their outcomes is implemented, in accordance with one embodiment of the present invention;

FIG. 2 illustrates a diagrammatic representation of the system, in accordance with one embodiment of the present invention;

FIG. 3 illustrates a block diagram of a processor, memory and a display unit, in accordance with one embodiment of the present invention;

FIG. 4 illustrates a block diagram of a user device, in accordance with one embodiment of the present invention;

FIG. 5 illustrates a method of detecting a website running split tests by recognizing visual or code changes on web pages, in accordance with one embodiment of the present invention;

FIG. 6 illustrates a method of detecting websites running split tests by executing a command, in accordance with one embodiment of the present invention;

FIG. 7 illustrates a method of detecting websites running split tests by detecting a code signature, in accordance with one embodiment of the present invention;

FIG. 8 illustrates a method of detecting websites running split tests by detecting cookies, in accordance with one embodiment of the present invention;

FIG. 9 illustrates a method of detecting a test and capturing initial data by comparing code or visual changes using a web crawler, in accordance with one embodiment of the present invention;

FIGS. 10 through 13 illustrate screenshots an interface presented to the user, in accordance with exemplary embodiments of the present invention; and

FIG. 14 illustrates a method of detecting and capturing information corresponding to split tests and their outcomes, in accordance with one embodiment of the present invention.

It will be noted that throughout the appended drawings, like features are identified by like reference numerals.

### DETAILED DESCRIPTION OF THE EMBODIMENTS

Before the present features and working principle of a system for detecting and capturing information corresponding to split tests and their outcomes is described, it is to be understood that this invention is not limited to the particular system as described, since it may vary within the specification indicated. Various features of the system for detecting and capturing information corresponding to split tests and their outcomes might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It should be understood that the present invention describes a system and a method for detecting and capturing information corresponding to split tests and their outcomes. The system identifies split tests being run on a third-party website or web page. The split test comprises one or more experimental arms corresponding to modifications of the third-party website or web page. The system identifies the arms of the split test and monitors changes in traffic allocation to the arms of the split test. Further, the system identifies one or more experimental arms as being winner arms based on detecting an increase in the traffic allocation to the arms or the modifications contained in the arms being subsequently detected on the site following the conclusion of the test. In one embodiment, the system identifies one or more experimental arms as being winner arms when the traffic is allocated substantially or completely to the arms. The system terminates identification of the split tests being run on the third-party website or web page upon detection of the winner arms or after some set period after detection of the winner arms.

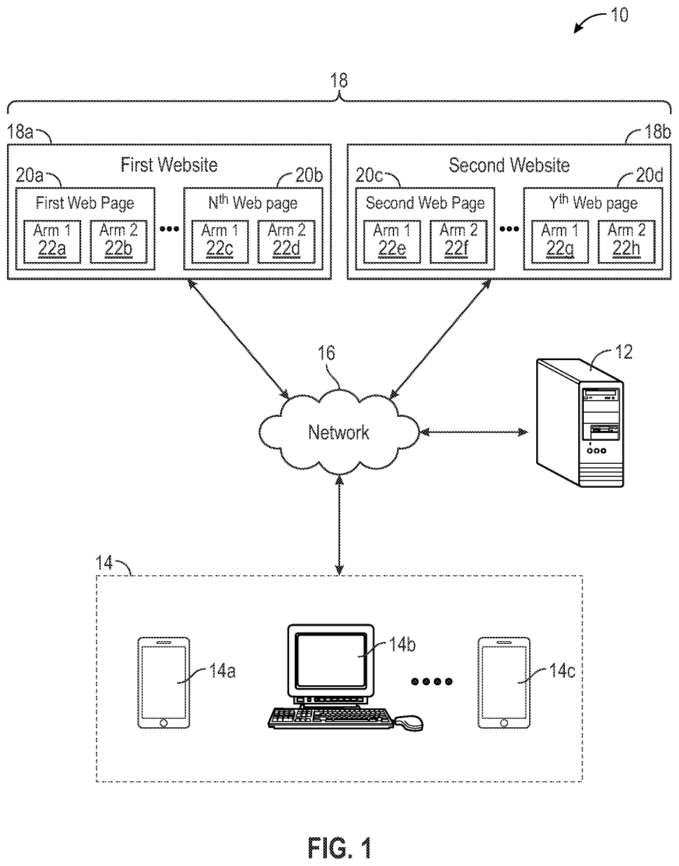

Various features and embodiments of the system for detecting and capturing information corresponding to split tests and their outcomes are explained in conjunction with the description of FIGS. 1-14.

In one embodiment, the present invention discloses a system for detecting and capturing information corresponding to split tests and their outcomes. FIG. 1 shows network environment 10 in which system 12 for detecting and capturing information corresponding to split tests and their outcomes implements, in accordance with one embodiment of the present invention. System 12 communicatively connects to plurality of user devices 14a, 14b . . . 14n collectively referred to as user devices 14 or simply user device 14, when referred to a single user device. As can be seen, system 12 and user devices 14 communicatively connect to each other via network 16.

In accordance with the present invention, system 12 crawls plurality of websites 18 (such as first website 18a, second website 18b, etc.) As known, each website 18 includes several web pages each having different Uniform Resource Locator (URL) and/or content such as text, images, videos and combination thereof. As such, first website 18a includes first webpage 20 through nth webpage 20b. Similarly, second website 18b includes second webpage 20c through yth webpage 20d.

System 12 includes an electronic device such as a mobile phone, a laptop, a tablet, a computer and so on. System 12 presents hardware and/or one or more applications configured to execute functions detecting and capturing information corresponding to split tests and their outcomes. In one embodiment, system 12 implements as a standalone device or connects (e.g., networked) to other systems via network 16. In another embodiment, system 12 implements in a client-server architecture, in that system acts as a server 12 and communicates with one or more client or user devices 14 over network 16.

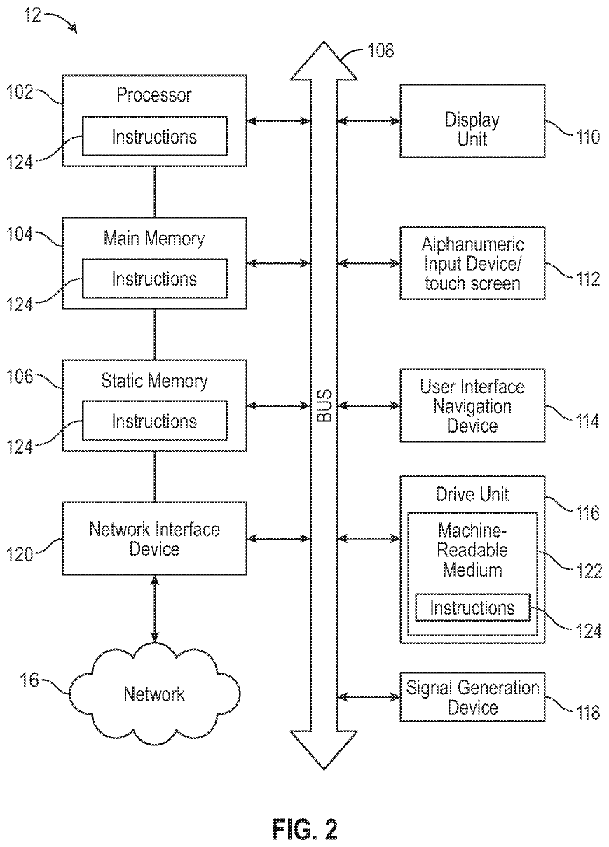

FIG. 2 shows a diagrammatic representation of system 12, in accordance with one embodiment of the present invention. System 12 includes processor 102 (e.g., a central processing unit (CPU), main memory 104 and static memory 106, which communicate with at least one other via bus 108.

Processor 102 includes any suitable processing device, such as a microprocessor, microcontroller, integrated circuit, logic device, or other suitable processing device.

Main memory 104 includes one or more computer-readable media, including, but not limited to, non-transitory computer-readable media, RAM, ROM, hard drives, flash drives, or other memory devices. Main memory 104 stores information accessible by processor 102, including computer-readable instructions 124 that are executed by processor 102. Instructions 124 include any set of instructions that when executed by processor 102, cause processor 102 to perform operations.

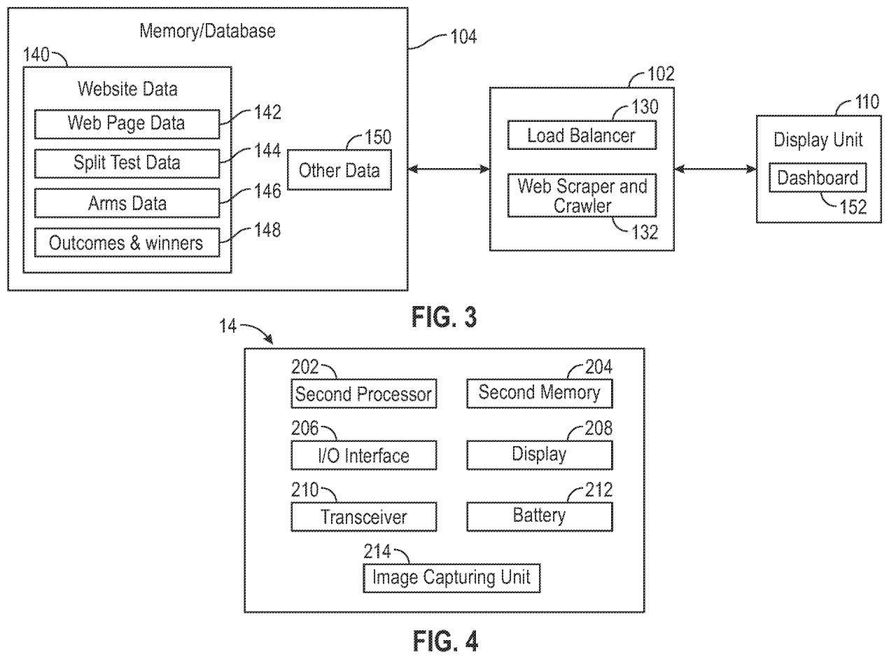

In one example, main memory 104 stores data that can be retrieved, manipulated, created, or stored by processor 102. The data includes, for instance, website data, webpage data, split test data, control and variations (arms) data, outcomes and winners' data and other data (FIG. 3).

Bus 108 provides a mechanism for letting the various components and subsystems of system 12 communicate with each other as intended. Although bus 108 is shown schematically as a single bus, alternative embodiments of bus 108 utilizes multiple buses. Bus 108 includes any of several types of bus structures including a memory bus or memory controller, a peripheral bus, and a local bus using any of a variety of bus architectures. For example, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

System 12 includes video display unit 110 (e.g., a liquid crystal display (LCD) or a cathode ray tube (CRT)). System 12 further includes an alphanumeric input device (e.g., a keyboard) and/or touchscreen 112, user interface (UI) navigation device 114 (e.g., a mouse), disk drive unit 116, signal generation device 118 (e.g., a speaker), and network interface device 120.

Disk drive unit 116 includes machine-readable medium 122 on which is stored one or more sets of instructions and data structures (e.g., software 124) embodying or utilized by any one or more of the methodologies or functions described herein. It should be understood that the term “machine-readable medium” includes a single medium or multiple media (e.g., a centralized or distributed database, and/or associated caches and servers) that stores one or more sets of instructions. The term “machine-readable medium” includes any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals.

Instructions 124 resides, completely or at least partially, within main memory 104 and/or within processor 102 during execution thereof by system 12, main memory 104 and processor 102 also constituting machine-readable media. Instructions 124 get transmitted or received over network 16 via network interface device 120 utilizing any one of a number of well-known transfer protocols.

In one exemplary implementation, processor 102 includes load balancer 130 and web scraper and crawler 132. Here, web scraper and crawler 132 crawls websites 18 across the world Wide Web (www) or internet and extracts data or information from websites 18. As known, a plurality of servers hosts websites 18 across various geographical locations. Web scraper and crawler 132 crawls through the servers hosting websites 18 using network 16. Load balancer 130 receives and distributes data requests and/or instructions to be processed by processor 102. In accordance with the present invention, websites 18 include one or more third-party websites, desktop or mobile applications and other media. For ease of reference, two websites i.e., first website 18a and second website 18b are considered. As known, each website includes one or more web pages each having a unique uniform resource location (“URL”). For example, a website or domain name www.site.com (say first website 18a) may have different web pages, say www.site.com/services (first webpage 20a) and www.site.com/products (nth webpage 20n). Similarly, a website www.sitly.com (say second website 18b) may have different web pages, say www.sitly.com/services (second webpage 20c) and www.sitly.com/products (yth webpage 20y).

As known, split testing is a technique used to measure the impact of a change on key metrics. Split testing techniques allocate traffic between test experiences and determine what if any experience has the most impact on the desired metrics. Examples of split testing includes, but not limited to, A/B testing, multivariate testing, bandit testing, Taguchi testing, and other types of statistical and artificial intelligence (AI) powered testing. The presently disclosed invention is explained considering that system 12 detects websites running A/B tests. However, a person skilled in the art understands that system 12 is capable of detecting and capturing information about any split tests running on websites and their outcomes without departing from the scope of the present invention.

A person skilled in the art understands that A/B testing helps to evaluate a user's reaction or engagement with a webpage, website, service, feature, or product. Typically, a website uses an A/B test to show two or more versions of a web page, email, offer, article, social media post, advertisement, layout, design, and/or other information or content to randomly selected sets of users to determine if one version has a higher conversion rate than the other. In this context, the existing version/experience/experiment is referred to as the “control”, and the new experiences/versions/experiments being tested against the control are referred to as “variants” or “variations”. In the present disclosure, any control and variants are referred as experimental arms or arms or simply arm, when referred to a single arm. As such, each webpage being tested includes arms. For the above example, first webpage 20a includes arm 1 22a and arm 2 22b, nth webpage 20n includes arm 1 22c and arm 2 22d, second webpage 20b includes arm 1 22e and arm 2 22f, and yth webpage 20y includes arm 1 22g and arm 2 22h. In one example, arm 1 refers to the control and arms 2 refers to variation(s) of the experimental split test. In another example both arms 1 and 2 refers to variations, where there is no control experiment.

In one exemplary implementation, memory 104 includes a database that stores website data 140, webpage data 142, split test data 144, arms data 146, outcomes and winners' data 148 and other data 150. Web scraper and crawler 132 crawls through websites 18 to detect the websites 18 running A/B tests. For each website, say first website 18a, web scraper and crawler 132 detects web pages 20a . . . 20n running A/B tests. Upon detecting, processor 102 instructs memory 104 to store website data 140, webpage data 142, A/B test data 144. Processor 102 employs web scraper and crawler 132 to crawl websites 18 and obtains arms data 146 and outcomes and winners' data 148. Subsequently, processor 102 instructs memory 104 to store arms data 146 and outcomes and winners' data 148. When user devices 14 access system 12, processor 102 retrieves data from memory 104 and presents on dashboard 152 of display unit 110 or on display 208 depending on the need.

System 12 exchanges data with user devices 14 over network 16, as shown in FIG. 1. A person skilled in the art understands that user devices 14 connect to system 12 over network 16. Each of user devices 14 indicates a suitable type of computing device, such as a general-purpose computer, special purpose computer, laptop, desktop, mobile device, navigation system, smartphone, tablet, wearable computing device, a display with one or more processors, or other suitable computing device. A tester includes an owner and operator of a website and/or software application interested to capture information about split tests and their outcomes. The tester uses user device 14 to crawl, collect, analyze and distribute test specifications, results and the like to determine/obtain information corresponding to the winner from one of the arms 22a; 22b in websites 18a, for example. Although it is explained that a single tester uses user device 14 to capture information about split tests and their outcomes, it is obvious to a person skilled in the art to understand that multiple testers can use their respective user devices 14 to capture information about split tests and their outcomes in several websites 18 at the same time without departing from the scope of the present invention.

Similar to system 12, each of user devices 14 includes second processor 202 and second memory 204, as shown in FIG. 4. Second processor 202 encompasses a central processing unit (CPU), a graphic processing unit (GPU) dedicated to efficiently rendering images or performing other specialized calculations, and/or other processing devices. Second memory 204 includes a computer-readable media that stores information accessible by processor 202, including instructions that can be executed by processor 202 and data.

User device 14 further includes an input/output interface 206, second display 208 and transceiver 210. Transceiver 210 helps in communicating with one or more remote computing devices (e.g., system 12) over network 16. Further, user device 14 includes battery 212 such as a rechargeable battery for powering user device 14. In addition, user device 14 further includes a network interface such as image-capturing unit 214 such as a camera used for capturing still images or video.

Network 16 includes any type of communications network, such as a local area network (e.g., intranet), wide area network (e.g., Internet), cellular network, or some combination thereof. Network 16 includes a direct connection between system 12, user device 14, and websites 18. In general, the communication between system 12 and user device 160 can be carried via a network interface using any type of wired and/or wireless connection, using a variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. One of the ordinary skilled in the art will recognize that the inherent flexibility of computer-based systems allows for a great variety of possible configurations, combinations, and divisions of tasks and functionality between and among components. For instance, system or server processes discussed herein may be implemented using a single server or multiple servers working in combination. Data and the applications might be implemented on a single system or distributed across multiple systems. Distributed components may operate sequentially or in parallel.

In accordance with one embodiment of the present invention, system 110 detects third-party websites 18 running split tests and captures information about the split tests. This helps to harvest information and determine the efficacy of split tests. The following description is explained considering a website having several web pages, however a person skilled in the art understands the teachings of the present invention can be applied to an application, or other media capable of being split tested.

In order to detect third-party websites 18 running split tests and capture information about the split tests, at first, system 12 generates and maintains a list of candidates to monitor. Here, system 12 monitors a set of websites 12 or web pages 20 that are currently running A/B tests, that are likely to run A/B tests in the future, or that are of particular interest. System 12 monitors websites 12 in real-time or periodically depending on the need. It is preferable to monitor periodically to allocate resources preferentially to analyzing websites 12 that are more likely to generate useful information. In accordance with the present invention, system 12 determines websites 12 running split tests using one of—detecting a webpage with testing software installed using web scraper and crawler 132, using pre-built lists, manually adding or removing websites, automatically adding or removing websites, and combination thereof.

In one embodiment, web scraper and crawler 132 detects websites 18 running split tests such as A/B tests for generating a list of candidate web pages. Here, web scraper and crawler 132 crawls the internet looking for websites 18 and/or web pages 20 that have testing software installed. For example, web scraper and crawler 132 crawls the internet periodically to look for websites 18 and/or web pages 20 having split testing software installed. Web scraper and crawler 132 starts crawling a known directory of websites such as DMOZ.org. After crawling, web scraper and crawler 132 follows all links i.e., web pages/URL 20 on website 18 and the sitemap associated with that website 18. Subsequently, web scraper and crawler 132 follows all links on those web pages 20 and the sitemaps of these websites, and so on. Web scraper and crawler 132 crawls each website to discover/identify whether the website or any of its web pages had testing software installed or was running a split test. Upon identifying, processor 102 creates a list of candidate websites or web pages and stores the information in memory 104. Web scraper and crawler 132 detects/determines websites 18 running split tests by recognizing visual or code changes on a webpage 18, or executing a command, or detecting a code signature or detecting cookies, or combination thereof.

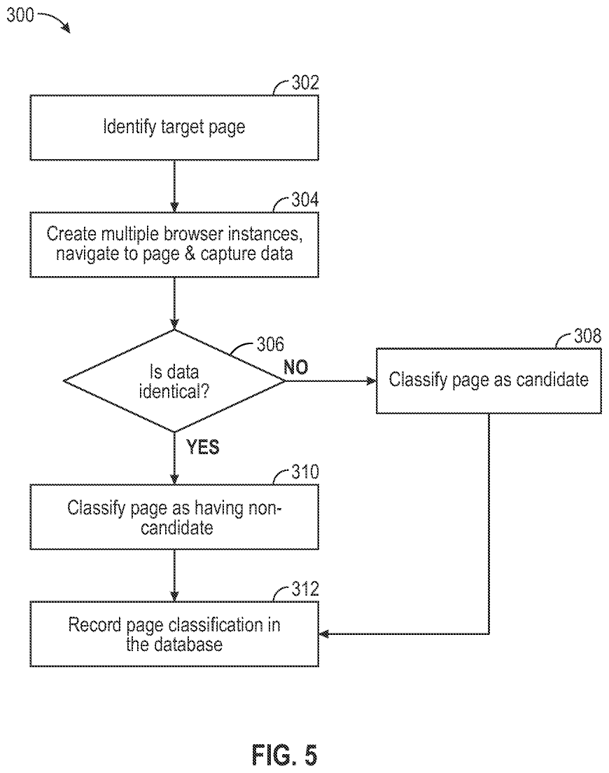

FIG. 5 illustrates method 300 of detecting websites 18 running split tests by recognizing visual or code changes on a webpage, in accordance with one embodiment of the present invention. The order in which method 300 is described should not be construed as a limitation, and any number of the described method blocks can be combined in any order to implement method 300 or alternate methods. Additionally, individual blocks may be deleted from method 300 without departing from the spirit and scope of the subject matter described herein. Furthermore, method 300 can be implemented in any suitable hardware, software, firmware, or combination thereof. However, for ease of explanation, in the embodiments described below, method 300 implements using the above-described system 12.

At step 302, scraper and crawler 132 crawls all third-party websites 18 and identifies website (say first website 18a i.e., target website). In one example, scraper and crawler 132 or processor 102 creates multiple instances of a headless browser, with multiple IP addresses, and visiting the target website and captures a rendered screenshot, HTML code, CSS code, JavaScript code, browser local storage, browser session storage, browser indexed database, cookies, and other information associated with the web pages, as shown at step 304.

At step 306, scraper and crawler 132 checks whether the data is identical at multiple instances. In one example, scraper and crawler 132 checks the data by comparing screenshots of the multiple instances and looking for visual differences. Here, the presence of differences indicates that a test may be running on the website. In another example, scraper and crawler 132 detects the visual differences using one of many third-party libraries such as Resemble.js. or by clustering the different screenshots. Based on the visual differences, system 12 generates an estimation of the traffic mix allocated to each particular arm.

If scraper and crawler 132 determines the data is not identical at step 306, then method 300 moves to step 308. At step 308, processor 102 classifies that website 18 detected is a possible candidate to monitor and stores the website data 140 and/or webpage data 142 in memory 104 (step 312). If scraper and crawler 132 determines the data is identical at step 306, then method 300 moves to step 310. At step 310, processor 102 classifies that website 18 detected is not a candidate to monitor and stores the website data 140 and/or webpage data 142 in memory 104 (step 312).

Detecting websites 18 running split tests by recognizing visual or code changes on a webpage provides several advantages. For example, recognizing visual or code changes allows the system to have browser instances that are from or can simulate being from different geographic regions, different cookie identifier, different devices (in particular mobile, tablet, and desktop devices), different screen resolutions, different languages, different connection speeds, different user types (in particular new and returning users, demographics, and employer and job profiles) and other characteristics that are commonly used to target testing efforts. In addition, recognizing visual or code changes allows the system to filter out false positives. Web pages, may for example, render differently or have different code associated with the page based on the variation in connection speed for the particular instances capturing the page. This can result in for example a popup or slider window being differently displayed on one instance than on another. Detecting or eliminating these false positives is done by techniques such as waiting until the page is fully loaded before capturing, by adjusting elements such as sliders and popups so they are all at the same position at the time of capture, or by filtering out these elements.

Furthermore, recognizing visual or code changes allows the system to directly inspect historical archives of a webpage. For example, the popular internet archive Wayback Machine (archive.org) provides a historical archive of over 500 billion web pages. This archive saves chronological versions of a web page. Inspecting changes in a series of saved archives of a single web page, and detecting changes reveal the presence of split testing.

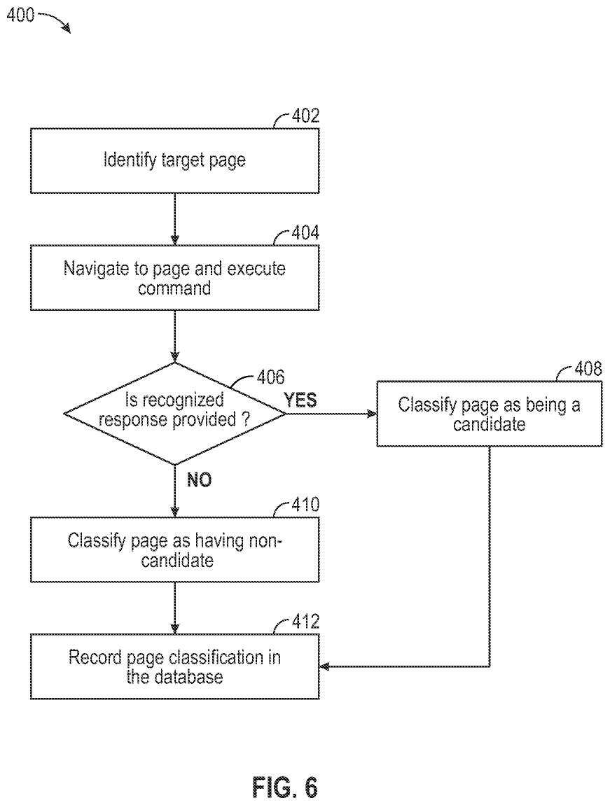

FIG. 6 illustrates method 400 of detecting websites 18 running split tests by executing a command, in accordance with one embodiment of the present invention. The order in which method 400 is described should not be construed as a limitation, and any number of the described method blocks can be combined in any order to implement method 400 or alternate methods. Additionally, individual blocks may be deleted from method 400 without departing from the spirit and scope of the subject matter described herein. Furthermore, method 400 can be implemented in any suitable hardware, software, firmware, or combination thereof. However, for ease of explanation, in the embodiments described below, method 400 implements using the above-described system 12.

Here, system 12 employs scraper and crawler 132 to detect the presence of testing software on third-party websites by a browser instance, such as Chrome or FireFox. After opening, scraper and crawler 132 attempts to execute a command that would only be successfully executed if testing software was installed. At step 402, scraper and crawler 132 crawls all third-party websites 18 and identifies website (say first website 18a i.e., target website). In one example, scraper and crawler 132 or processor 102 navigates to a webpage and executes a command in the browser, as shown at step 404.

At step 406, scraper and crawler 132 checks whether executing the command on the browser instance has provided a response. If scraper and crawler 132 gets a response at step 406, then method 400 moves to step 408. At step 408, processor 102 classifies that website 18 detected is a possible candidate to monitor and stores the website data 140 and/or webpage data 142 in memory 104 (step 412). If scraper and crawler 132 receives an “undefined” response at step 406, then method 400 moves to step 410. At step 510, processor 102 classifies that website 18 detected is not a candidate to monitor and stores the website data 140 and/or webpage data 142 in memory 104 (step 412).

In one example, scraper and crawler 132 executes the command “google_optimize” to detect the presence of the commercial testing software Google Optimize. If Google Optimize was installed on the webpage, then following the execution of the command, an object would be returned. If Google Optimize was not installed, then “undefined” would be returned.

In another example, scraper and crawler 132 executes the command “optimizely.get(‘data’)” to detect the presence of the commercial testing software Optimizely. If Optimizely was installed on the webpage, then following the execution of the command, an object would be returned. If Optimizely was not installed, then “undefined” would be returned.

In yet another example, scraper and crawler 132 executes the command “_vwo_exp” to detect the presence of the commercial testing software Visual Website Optimizer. If Visual Website Optimizer was installed on the webpage, then following the execution of the command, an object would be returned. If Visual Website Optimizer was not installed, then “undefined” would be returned.

Optionally, scraper and crawler 132 executes additional commands that would reveal the presence of split testing software installed on the websites and such implementations are obvious to a person skilled in the art.

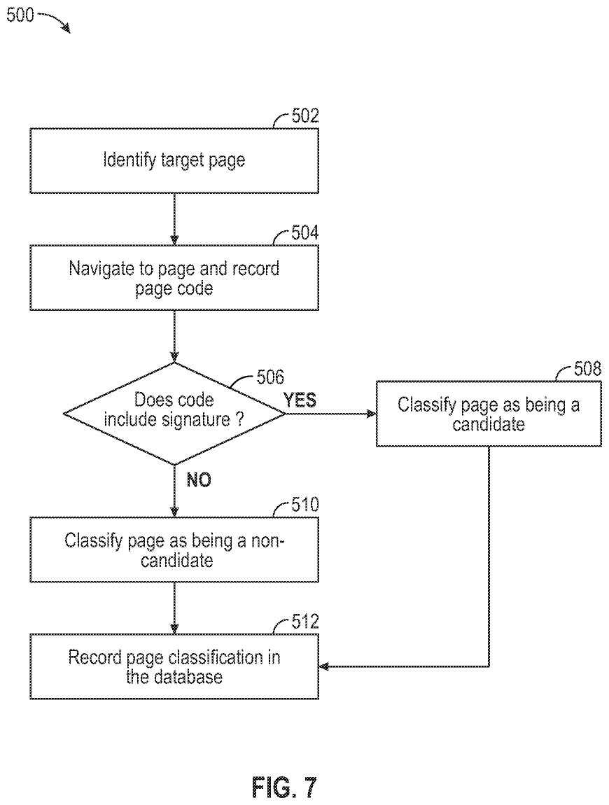

FIG. 7 illustrates method 500 of detecting websites 18 running split tests by detecting a code signature, in accordance with one embodiment of the present invention. The order in which method 500 is described should not be construed as a limitation, and any number of the described method blocks can be combined in any order to implement method 500 or alternate methods. Additionally, individual blocks may be deleted from method 500 without departing from the spirit and scope of the subject matter described herein. Furthermore, method 500 can be implemented in any suitable hardware, software, firmware, or combination thereof. However, for ease of explanation, in the embodiments described below, method 500 implements using the above-described system 12.

Here, system 12 employs scraper and crawler 132 to detect the presence of testing software on third-party websites by looking for a signature associated with the testing software. As known, testing software uses a code snippet that is added to the code on each page where the software is installed. In the present embodiment, scraper and crawler 132 detects such code snippet on a given web page. At step 502, scraper and crawler 132 crawls all third-party websites 18 and identifies website (say first website 18a i.e., target website). In one example, scraper and crawler 132 or processor 102 navigates to the webpage and records the page code, as shown at step 504. At step 506, scraper and crawler 132 checks whether code includes a signature. If scraper and crawler 132 detects the code at step 506, then method 500 moves to step 508. At step 508, processor 102 classifies that website 18 detected is a possible candidate to monitor and stores the website data 140 and/or webpage data 142 in memory 104 (step 512). If scraper and crawler 132 determines the website does not include signature at step 506, then method 500 moves to step 510. At step 510, processor 102 classifies that website 18 detected is not a candidate to monitor and stores the website data 140 and/or webpage data 142 in memory 104 (step 512).

In one example, scraper and crawler 132 crawls the website to detect the presence of the commercial testing software Google Optimize. Here, the scraper and crawler 132 crawls for the code of a webpage to find a code signature similar to the following: ga(‘require’, ‘GTM-xxxxxx’) (where xxxxxx is a string of integers). Alternatively, scraper and crawler 132 inspects the webpage to find a code signature similar to the following: <script src=“https://www.googleoptimize.com/optimize.js?id=xxxxxx”></scr ipt> (where xxxxxx was some string of integers).

In another example, scraper and crawler 132 crawls the website to detect the presence of the commercial testing software Optimizely. Scraper and crawler 132 crawls the website to inspect the code of a web page to find a code signature similar to the following: <script src=“https://cdn.optimizely.com/js/xxxxxxxxxx.js”></script> (where xxxxxxxxxxx was some string of integers).

In another example, scraper and crawler 132 crawls the website to detect the presence of the commercial testing software Visual Website Optimizer to find a code signature.

Optionally, scraper and crawler 132 crawls websites to find additional code signatures that would reveal the presence of split testing software installed on the websites and such implementations are obvious to a person skilled in the art.

Finding code signatures provides an advantage in that it is computationally inexpensive and detects the presence of testing software even when a test is not currently being run.

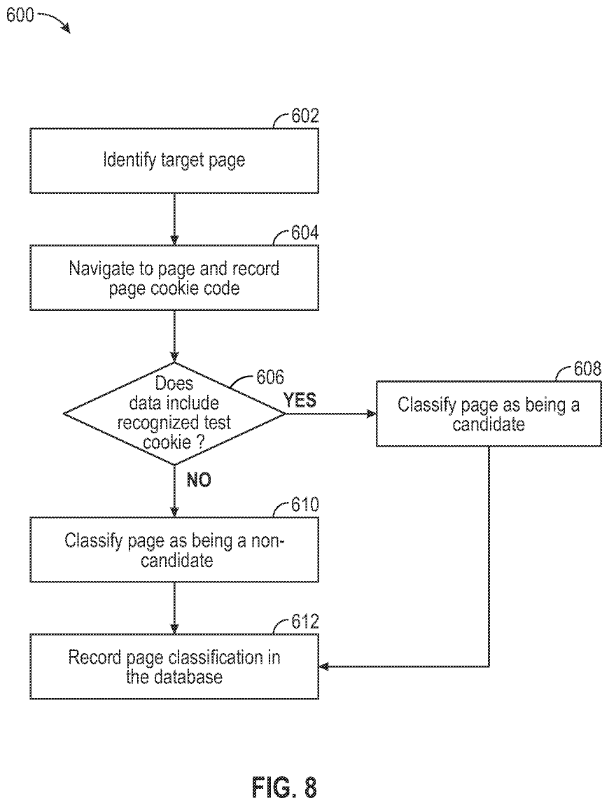

FIG. 8 illustrates method 600 of detecting websites 18 running split tests by detecting cookies, in accordance with one embodiment of the present invention. Method 600 can be implemented in any suitable hardware, software, firmware, or combination thereof. However, for ease of explanation, in the embodiments described below, method 600 implements using the above-described system 12.

Here, system 12 employs scraper and crawler 132 to look for cookies stored on the client browser. As known, testing software uses client-side cookies to identify users who are part of a test and to identify which test cohort they belong to. Here, scraper and crawler 132 identifies whether a webpage is running tests by creating a headless browser instance, browsing a particular page, and inspecting the cookies created on the webpage.

At step 602, scraper and crawler 132 crawls all third-party websites 18 and identifies website (say first website 18a i.e., target website). In one example, scraper and crawler 132 or processor 102 navigates to the webpage and records the page cookie code, as shown at step 604. At step 506, scraper and crawler 132 checks whether data include test cookies. If scraper and crawler 132 detects test cookies at step 606, then method 600 moves to step 608. At step 608, processor 102 classifies that website 18 detected is a possible candidate to monitor and stores the website data 140 and/or webpage data 142 in memory 104 (step 612). If scraper and crawler 132 determines the website does not include test cookies at step 606, then method 600 moves to step 610. At step 610, processor 102 classifies that website 18 detected is not a candidate to monitor and stores the website data 140 and/or webpage data 142 in memory 104 (step 612).

For instance, scraper and crawler 132 inspects browser instance cookies to look for a cookie to detect an experiment running on commercial testing software such as Google Optimize. The browser instance cookies include a cookie similar to the following:

Cookie name=_gaexp

Cookie value=some string

In another example, scraper and crawler 132 inspects browser instance cookies to look for a cookie to detect an experiment running on commercial testing software such as Optimizely. The browser instance cookies include a cookie similar to the following:

Cookie name=optimizelyEndUserId

Cookie value=some string

In another example, scraper and crawler 132 inspects browser instance cookies to look for a cookie to detect an experiment running on commercial testing software such as Visual Website Optimizer. The browser instance cookies include a cookie similar to the following:

Cookie name=_vis_opt_expID_TestType

Cookie value=Number

In one alternate embodiment, testing software may use browser local storage to identify users or identify an experiment cohort. As such, scraper and crawler 132 inspects local storage to identify web pages that are running split tests.

Optionally, scraper and crawler 132 finds additional cookie signatures that reveal the presence of split testing software installed on the websites and such implementations are obvious to a person skilled in the art.

As specified above, system 12 generates and maintains a list of candidates by detecting a webpage with testing software installed using web scraper and crawler pre-built lists, manually adding or removing websites, automatically adding or removing websites, and combination thereof. In order to generate and maintain a list of candidates using pre-built lists, system 12 uses commercially available lists of sites known to run particular testing software. For example, commercially available websites such as BuiltWith.com and Wappalyzer.com provide lists of sites known to run common testing software tools, including Google Optimize, Optimizely, Visual Website Optimizer, A/B Tasty, Adobe Test & Target, Monetate, Maxymiser, Unbounce, and more. System 12 fetches the websites running the split tests directly from the commercially available lists of sites.

In one implementation, testers or users of user devices 14 manually generate a list of candidates i.e., websites and web pages of competitors running the split tests. Users manually generate the list and they are stored in memory 104.

In one implementation, system 12 automatically adds or removes websites and web pages from the list if they meet certain criteria or machine generated rules. For example, system 12 automatically adds or removes a website or webpage from the list if after a certain time it did not meet some criteria for producing useful information. One possible reason for removal is that the website did not run any test over a 90-day period; it could be marked to be not crawled, or to be crawled less frequently.

After identifying the websites running split tests using any one or combinational methods explained above, system 12 augments the list with other fields that can be scraped from the website or from third party sources. For example, system 12 augments data regarding the number of pages being tested, the specific pages being tested, the frequency or latest changes made, the approximate amount of traffic, the type of website, the website CMS, the industry, the type of business, and the primary conversion targets.

Once a website or webpage has been identified as of interest, system 12 examines each page to determine if a test was running on those individual pages. In some circumstances, it may be necessary to prioritize resources and analyze only a limited number of pages. In such a case, system 12 categorizes the pages and ranks them to determine their priority. For example, system 12 identifies key pages and categorizes them to be highly linked, identifies particular page types thought to be important, identifies a representative sample of pages using criteria such as the URL structure or page template, or some other criteria to identify pages of interest. Here, system 12 samples pages of a particular type, so that every page of a type may not need to be scraped. For example, on an ecommerce site, instead of scraping every product page, system 12 scrapes only a sampling of product pages.

System 12 periodically observes the website and web pages to identify new split tests running on the site and to identify any changes in the tests previously identified. System 12 continuously observes to add new tests being run to a database and allows information to be gathered about the tests outcomes. For example, if system 12 detects a webpage running a test using a web crawler (method 300), then system 12 utilizes the same technique to identify the split tests running on the site. This helps to identify any changes in the test.

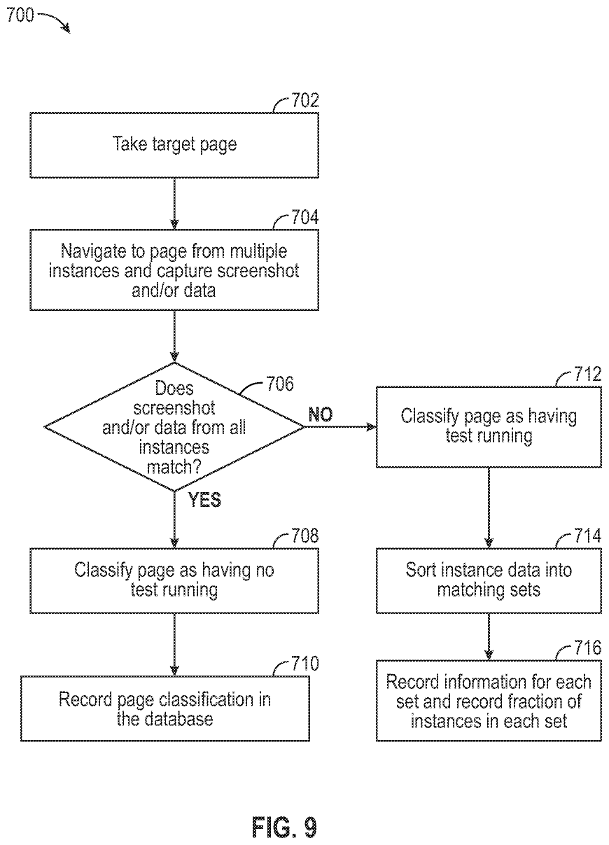

Now referring to FIG. 9, a method 700 of detecting a test and capturing initial data by comparing code or visual changes using a web crawler is explained, in accordance with one embodiment of the present invention. The order in which method 700 is described should not be construed as a limitation, and any number of the described method blocks can be combined in any order to implement method 700 or alternate methods.

Additionally, individual blocks may be deleted from method 300 without departing from the spirit and scope of the subject matter described herein. Furthermore, method 700 can be implemented in any suitable hardware, software, firmware, or combination thereof. However, for ease of explanation, in the embodiments described below, method 700 implements using the above-described system 12.

At step 702, scraper and crawler 132 takes the target website that has been detected running a split test. As specified above, presence of a test running on a webpage is detected by recognizing image or code changes on a webpage. As such, running the split tests result in changes to the rendered webpage. In order to capture the changes, system 12 visits a webpage multiple independent times and compares the results from these visits to recognize when a test was being run. For example, system 12 creates multiple instances of a headless browser, with multiple IP addresses, and visiting a given webpage and capturing a rendered screenshot, HTML code, CSS code, JavaScript code, browser local storage, browser session storage, browser indexed database, and cookies.

In order to capture the visual changes to the website, screenshots of the multiple instances are captured for looking for visual differences, as shown at step 704. Here, the presence of differences is indicative that a test is running. At step 706, system 12 checks whether the screenshot and/or data from all instances match. If they match, then method 700 moves to step 708. At step 708, the page is classified as not running a test. Further, the page is stored in the database/memory 104 at step 710. If at step 706, the screenshots and/or data do not all match, then method 706 moves to step 712. At step 712, page is classified as running the test. At step 714, the page is sorted into matching sets with other similar pages. At step 716, the information for each set and fraction of instances corresponding to each set is recorded.

In another example, the differences are captured by comparing differences in code, cookie data, browser local storage data, browser session storage data, or browser indexed database entries in the multiple instances. If there is a change, then it is inferred that a test is running. Further, the different arms are clustered to generate an estimate of the traffic mix allocated to each particular arm.

System 12 scrapes the webpage multiple times to generate information about the number of arms and the relative amount of traffic allocated to each arm. By utilizing a significantly large number of scraper runs, and detecting and collecting differences between each run, system 12 detects the number of arms and generates an estimate of the allocation of traffic to the arms. In order to increase the precision of these estimates, system 12 increases the number of runs (sample size).

In one embodiment, if a test is detected by crawling the visual changes, then system 12 compares the existing tests already logged in memory/database 104. By comparing the image or code of the arms to the image and code stored in the database, system 12 identifies if the test already exists in memory/database 104. If a test already exists in the database, then a new entry with the updated test parameters can be recorded in the test record along with the time at which the data was captured. If a test is detected that does not exist in memory/database 104, then system 12 adds the test as a new record in memory/database 104. System 12 adds the time at which the test was first encountered along with additional test information captured including the number of arms in each test, traffic allocation for each arm, images and code for each arm, and variation URLs.

In another embodiment, if the webpage running the split test is detected by executing a command on the website (method 400), then system 12 compares the data with existing tests already logged in memory 104. As known, test software typically provides a unique identifier for a test. Here, system 12 compares the identifier of a test with that of records in memory 104 that were previously identified to identify if the test already exists in memory 104. If a test already exists in memory 104, then a new entry with the test parameters is recorded in the test record along with the time at which the test data was captured. Further, if a test is detected that does not exist in memory 104, then system 12 adds the test as a new record in memory 104. Here, each record contains the time at which the test was first encountered along with additional test information captured including the test identifier, test names, the name and number of arms in each test, traffic allocations for the test and each arm, test targeting, variation code or variation URLs (arm code), and the test goals. Additionally, screen captures of test arms and code associated with each arm is captured and stored in memory 104.

In one exemplary embodiment, system 12 induces the commercial testing software, such as “Google Optimize” to show a particular arm, by running the command window[“optimizely”].push({“type”: “bucketVisitor”, “experimentId”: “XXXXXXXXXX”, “variationIndex”: Y}), where XXXXXXXXXXX and Y are integers representing the experiment number and arm of the experiment respectively, that it is desired to display. In another example, system 12 induces the commercial testing software, such as “Visual Website Optimizer” to show a particular arm, by running the command document.cookie=‘_vis_opt_exp_XX_combi=Y, where XX and Y are integers representing the experiment number and arm of the experiment respectively, that it is desired to display. A person skilled in the art understands that information on how to induce software to display a variation can be determined by examining developer documentation provided by testing software vendors or by inspecting the cookies and public functions associated with a particular testing software.

At any given point of time, if system 12 identifies a new test, then system 12 adds a new record in memory 104 to identify the new test. The record includes information such as screenshots and code for the tests. Subsequently, system 12 periodically checks the page associated with the test to see if there have been any changes to the test. If no change is detected, then the information is recorded in memory 104 indicating the date and time of the review and that there has been no chance. If a change is detected, such as a change in test traffic allocation, then the date and time of the review are recorded in memory 104 along with the changes observed.

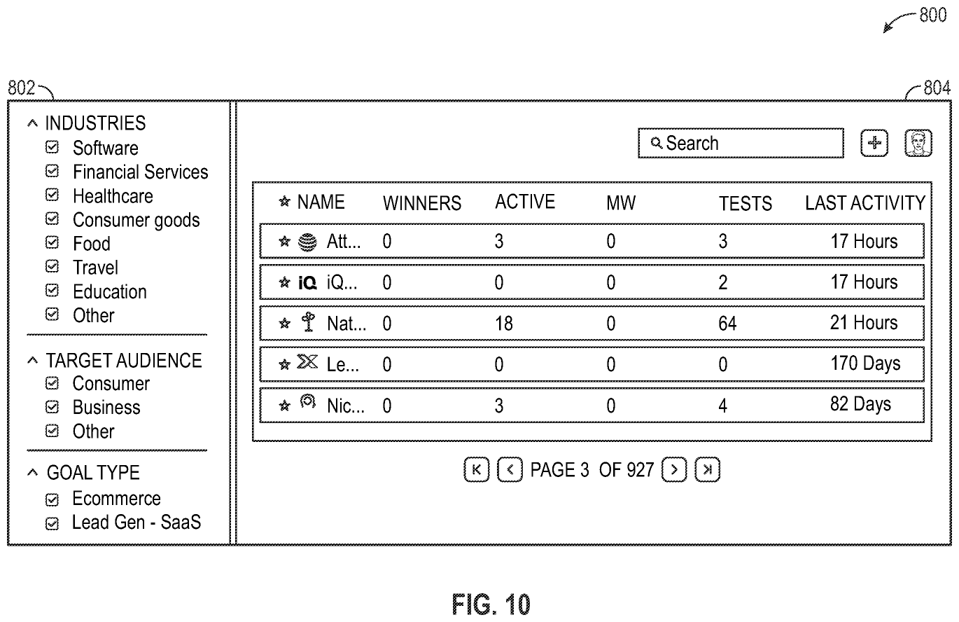

In one embodiment, system 12 presents an interface to allow users of user devices 14 to retrieve a subset of tests that may be of interest to them. Further, system 12 presents cumulative test data to the user and allows the user to identify the subset of tests that are of interest to them. Furthermore, system 12 allows the user to input a query to quickly identify tests. The interface allows the users to easily sort and filter data based on characteristics including website name, industries, goal types, test winner or not winner, dates, and more. A person skilled in the art understands that the interface enables the user to view, search, sort, and filter results. FIGS. 10 to 13 show exemplary screenshots that system 12 presents on display unit 110 corresponding to websites running the split tests, in accordance with one embodiment of the present invention.

FIG. 10 shows exemplary screenshot 800 having first section 802 and second section 804. First section 802 presents the type of websites classified based on their industry, product, or service category. In one example, system 12 obtains the list of websites running the split tests and categories them based on industry type such as software, financial services, healthcare, food, travel, etc. In another example, the system 12 obtains the list of websites running the split tests and categories them based on the audiences targeted by the websites. In another example, the system 12 obtains the list of websites running the split tests and categorizes them based on the goals of the websites owners such as ecommerce, lead generation, etc. Second section 804 presents name or domain of website, number of tests, and number of active tests being run on the website or webpages, time since last activity or last change in webpage or variants, etc.

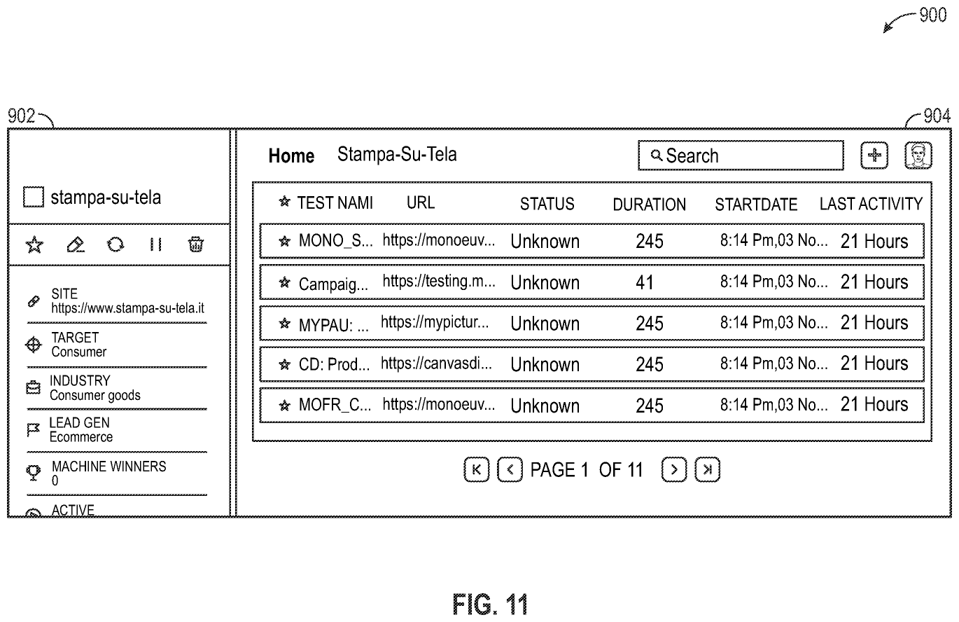

FIG. 11 shows exemplary screenshot 900 of capturing data of a specific website, in accordance with one embodiment of the present invention. Screenshot 900 presents first section 902 and second section 904. First section 902 presents details of the website such as URL, industry type, goal, etc. Second section 904 captures the name of the test detected, URL, current status of the test, start date of the test, duration of the test being run on the website, duration of the test being monitored, last activity detected, etc.

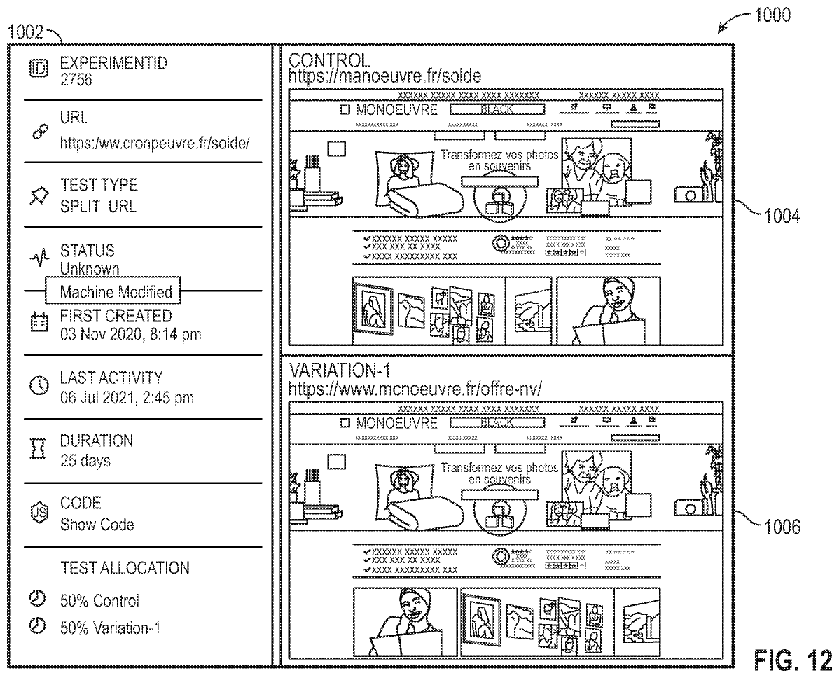

FIG. 12 shows exemplary screenshot 1000 of recognizing visual, code, cookie and other changes on the website, in accordance with one embodiment of the present invention. As specified, a website typically includes “control”, and “variants” or “variations”, referred to as “arms”. As such, system 12 monitors each website or web pages continuously and captures the visual, code, cookie and other changes on the website or webpage. Screenshot 1000 presents first section 1002, second section 1004 and third section 1006. First section 1002 presents a unique ID of the experiment being run on the website or webpage. Here, system 102 captures and presents the URL of the website or webpage, type of test, date on which the experiment has started, last activity detected on the website, duration of the experiment being run, and test allocation of the experiment between 0 to 100% for each of the arms. Second section 1004 shows existing version/experience/experiment of the website. Third section 1006 shows new experiences/versions/experiments being tested against the arm 1 (control) as an arm 2 (variation-1).

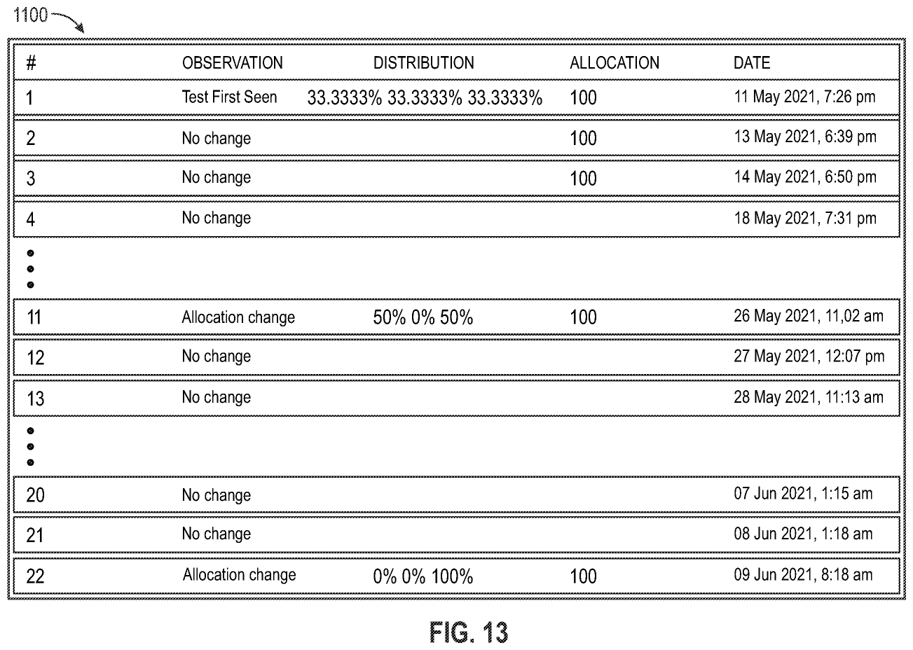

FIG. 13 shows exemplary screenshot 1100 presenting allocation/distribution of traffic between arms captured at different time intervals, in accordance with one embodiment of the present invention. Screenshot 1100 also presents the observation of the user based on the allocation/distribution of traffic at any given point of time.

System 12 continuously monitors the split tests until the split test is terminated at the website. System 12 considers the conclusion of a test based on several criteria. In one example, system 12 considers the conclusion of a test if the traffic allocation on the test is changed to being 100% or close to 100% for any one test arm for one or more observation intervals. Allocating all traffic or substantially all traffic to a single arm after a period of testing is indicative, that the operator of the website has determined that this arm is the winner, and wishes to allocate most traffic to this winner arm to reap the benefits of this arm. When system 12 detects that the allocation for a particular arm is increased to being 100% or close to 100%, that arm is marked as being a winner and the test is marked as having ended.

In another example, system 12 considers the conclusion of a test when the test is no longer detected by the system for one or more observation intervals. Ending a test is indicative that the website operator has determined that one or more arms has won and that the website operator intends to hard-code the changes for one of these arms in the future, or that the website operator has determined that the modified arms do not outperform the default arm (control) and that they intend to continue using the default arm experience.

When system 12 detects that a test has ended the test is marked as having ended in the database. System 12 continues to monitor the test page to determine if the changes contained in the arm are eventually implemented into the page.

In order to explain how the winner of an A/B test can be detected by monitoring allocation to arms, an example is presented in Table 1. Table 1 shows a test being run on a webpage with arms that are being scraped daily. The numbers indicate the percentage of traffic being allocated to each arm of the test.

TABLE 1
Table 1: Traffic allocation between arms

| | Control | Variation 1 | Variation 2 | Variation 3 |
|---|---|---|---|---|
| Day | (Arm 1) | (Arm 2) | (Arm 3) | (Arm 4) |
| 1 | 25% | 25% | 25% | 25% |
| 2 | 25% | 25% | 25% | 25% |
| 3 | 25% | 25% | 25% | 25% |
| 4 | 25% | 25% | 25% | 25% |
| 5 | 33% | 0% | 33% | 33% |
| 6 | 33% | 0% | 33% | 33% |
| 7 | 33% | 0% | 33% | 33% |
| 8 | 33% | 0% | 33% | 33% |
| 9 | 33% | 0% | 33% | 33% |
| 10 | 50% | 0% | 0% | 50% |
| 11 | 50% | 0% | 0% | 50% |
| 12 | 50% | 0% | 0% | 50% |
| 13 | 50% | 0% | 0% | 50% |
| 14 | 0% | 0% | 0% | 100% |

In the above example, it can be inferred from the website operator changing the traffic allocation to divert 100% of the traffic to arm 4 on Day 14, that arm 4 was the winner of the A/B test. Accordingly, system 12 tags arm 4 as “winner” and stores in memory 104. Further, system 12 tags arms 1, 2 and 3 as “not winner.” Further, system 12 tags the test as ended on Day 14.

Even after detecting the winner, system 12 continues to capture data from the website or web pages. System 12 continues to capture the webpage screenshots and code for a period (say three months) following the end of the test. In one example, system 12 continues to capture the webpage screenshots and code where it detects that the test has ended without the traffic being allocated 100% or close to 100% to some arm. Once the test is flagged as “ended”, then web scraper and crawler 132 captures images and code of the page periodically for a period following the ending of the test. This is done to compare the images and code of the page with existing images and code in memory 104. System 12 detects similarities by comparing the images and code on the page from these subsequent capture to the images and code for the page stored for the arms. When substantial similarities are detected to one of the arms, it is inferred that the arm was determined by the website operator to be a winner and was subsequently hard-coded into the website. The arm is tagged in memory/database 104 as a winner. When the subsequent captures of the webpage are determined to be similar to the control arm, it can be inferred that the website operator did not find any of the arms to be superior and any of the test was not a winner. The modified arms are then tagged in memory/database 104 as “not winner.”

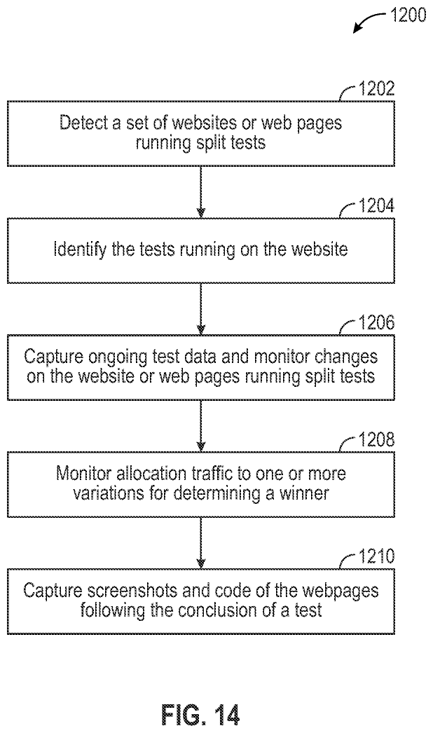

FIG. 14 illustrates method 1200 of detecting and capturing information corresponding to split tests and their outcomes, in accordance with one embodiment of the present invention. The order in which method 1200 is described should not be construed as a limitation, and any number of the described method blocks can be combined in any order to implement method 1200 or alternate methods. Additionally, individual blocks may be deleted from method 1200 without departing from the spirit and scope of the subject matter described herein. Furthermore, method 1200 can be implemented in any suitable hardware, software, firmware, or combination thereof. However, for ease of explanation, in the embodiments described below, method 1200 implements using the above-described system 12.

At step 1202, system 12 employs web scraper and crawler 132 crawl all websites and detect a set of websites or web pages running split tests (or webpage with testing software installed). As specified above, system 12 detects the webpage with testing software installed using one of—web scraper and crawler 132, pre-built lists, manually adding or removing websites, automatically adding or removing websites, and combination thereof. Here, system 12 detects, generates a list of candidate web pages and stores in memory 104.

After identifying the websites running A/B tests, system 12 identifies the tests running on the website, as shown at step 1204. Subsequently, system 12 captures ongoing test data and monitors changes on the website or web pages running A/B tests, as shown at step 1206. For example, if system 12 detects site or web pages running A/B test by recognizing visual or code changes on a webpage at step 1202, then system 12 captures screenshots of the multiple instances for looking for visual differences. System 12 captures the visual differences and monitors allocation traffic to arms for determining a winner, as shown at step 1208. As specified above, system 12 monitors allocation of traffic to arms until one is allotted 100% or substantial traffic indicating that the website owner has considered that experiment as a winner. After the experiment ends, system 12 continues periodically capturing screenshots and code for the pages being A/B tested to determine if any of the arms was hard coded into the site indicating that the website owner considered it a winner and concluded the test (step 1210).

After obtaining data from winning experiments run on third-party websites, a business owner will be able to prioritize similar experiments for implementation on their own website. Further, the business owner, after obtaining information on losing experiments run on third-party websites, can deprioritize similar experiments for implementation on their own website.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in figures are provided for illustrative purposes only and should not be construed in a limited sense. A person skilled in the art will appreciate alternate components that might be used to implement the embodiments of the present invention and such implementations will be within the scope of the present invention.

While preferred embodiments have been described above and illustrated in the accompanying drawings, it will be evident to those skilled in the art that modifications may be made without departing from this invention. Such modifications are considered as possible variants comprised within the scope of the invention.

What is claimed is:

1. A method of detecting and capturing information corresponding to a split test, the method comprising:
identifying, by a processor, a split test being run on a third-party website or web page, the split test comprising one or more experimental arms corresponding to modifications of the third-party website or web page;
identifying, by the processor, the arms of the split test;
monitoring, by the processor, changes in traffic allocation to the arms of the split test; and
identifying, by the processor, one or more experimental arms as being winner arms based on one of:
an increase in the traffic allocation to the arms, and
modifications contained in the arm or arms being detected on the website or web page following the conclusion of the test.

2. The method of claim 1, further comprising determining, by the processor, a list of candidate websites or webpages running split tests.

3. The method of claim 1, further comprising identifying, by the processor, one or more experimental arms as being winner arms when the traffic is allocated substantially or completely to the arms.

4. The method of claim 1, wherein the split test comprises one of an A/B testing, a multivariate testing, a bandit testing, a Taguchi testing, and a statistical and artificial intelligence (AI) powered testing.

5. The method of claim 1, wherein the step of identifying, by the processor, the split test being run on the third-party website or webpage, comprises:
recognizing visual or code changes on the webpage or web page by creating multiple instances of a browser; or
capturing a screenshot, Hypertext Mark-up Language, (HTML) code, Cascading Style Sheets (CSS) code, JavaScript code, browser local storage, browser session storage, browser indexed database, cookies, or other information associated with the website or web page.

6. The method of claim 1, wherein the step of identifying, by the processor, the split test being run on the third-party website or webpage, comprises:
executing a command using a browser instance on the website or web page.

7. The method of claim 1, wherein the step of identifying, by the processor, the split test being run on the third-party website or webpage, comprises:
detecting a code signature associated with a testing program code installed on the website or web page.

8. The method of claim 1, wherein the step of identifying, by the processor, the split test being run on the third-party website or webpage, comprises:
identifying cookies stored on a client browser running the website or web page.

9. The method of claim 2, wherein the step of determining, by the processor, a list of candidate websites or webpages running the split test, comprises one of:
generating the list of candidate websites or webpages using a pre-built list;
manually adding or removing the candidate websites or webpages; and
automatically adding or removing the candidate websites or webpages based on predefined criteria.

10. The method of claim 3, further comprising terminating, by the processor, identification of the split test being run on the third-party website or web page upon detection of the winner arms.

11. The method of claim 1, wherein the step of monitoring, by the processor, changes to the arms of the split test, comprises:
scraping the website or web page multiple times to generate information about the number of arms and the relative amount of traffic allocated to each arm.

12. A system for detecting and capturing information corresponding to a split test, the system comprising:
a processor; and
a memory coupled to the processor, wherein the processor is configured to execute program instructions stored in the memory, to:
identify a split test being run on a third-party website or web page, wherein the split test comprises one or more experimental arms corresponding to modifications of the third-party website or web page;
identify the arms of the split test;
monitor changes in traffic allocation to the arms of the split test; and
identifying one or more experimental arms as being winner arms based on one of:
an increase in the traffic allocation to the arms, and
modifications contained in the arm or arms being detected on the website or web page following the conclusion of the test.

13. The system of claim 12, wherein the processor executes the program instructions to determine a list of candidate websites or webpages running the split test.

14. The system of claim 12, wherein the processor executes the program instructions to identify one or more experimental arms as being winner arms when the traffic is allocated substantially or completely to the arms.

15. The system of claim 12, wherein the split test comprises one of an A/B testing, a multivariate testing, a bandit testing, a Taguchi testing, and a statistical and artificial intelligence (AI) powered testing.

16. The system of claim 12, wherein the processor identifies the split test being run on the third-party website or webpage, by:
recognizing visual or code changes on the webpage or web page by creating multiple instances of a browser; or
capturing a screenshot, Hypertext Mark-up Language, (HTML) code, Cascading Style Sheets (CSS) code, JavaScript code, browser local storage, browser session storage, browser indexed database, cookies, and other information associated with the website or web pages.

17. The system of claim 12, wherein the processor identifies the split test being run on the third-party website or webpage, by:
executing a command using a browser instance on the website or web page; or
detecting a code signature associated with a testing program code installed on the website or web page; or
identifying cookies stored on a client browser running the website or web page.

18. The system of claim 13, wherein the processor determines the list of candidate websites or web pages by:
generating the list of candidate websites or web pages using a pre-built list; or
manually adding or removing the candidate websites or web pages; or
automatically adding or removing the candidate websites or web pages based on predefined criteria.

19. The system of claim 12, wherein the processor executes the program instructions to terminate identification of the split test being run on the third-party website or web page upon detection of the winner arms.

20. A method of detecting and capturing information corresponding to a split test, the method comprising:
identifying, by a processor, a split test being run on a third-party website or web page, the split test comprising one or more experimental arms corresponding to modifications of the third-party website or web page;
identifying, by the processor, the arms of the split test;
monitoring, by the processor, changes in traffic allocation to the arms of the split test; and
identifying, by the processor, one or more experimental arms as being winner arms based on increase in the traffic allocation to the arms or based on the modifications contained in the arms being detected on the website or web page following the conclusion of the test.
